(19) United States
(12) Patent Application Publication
(10) Pub. No.: US 2016/0294834 A1
(43) Pub. Date: Oct. 6, 2016

(54) ACCOUNT INFORMATION RELEASER

(71) Applicant: TangoMe, Inc., Mountain View, CA (US)

(72) Inventor: Diego BESPROSVAN, Palo Alto, CA (US)

(21) Appl. No.: 14/673,718

(22) Filed: Mar. 30, 2015

(51) Int. Cl. H04L 29/06; H04L 29/08

(52) U.S. Cl. CPC H04L 63/102; H04L 67/306

(57) ABSTRACT

A method for releasing account information to a network device, including: receiving, over a communication network, from a first network device that has installed thereon an application, a first input, wherein the first input includes a request for access to profile specific information associated with a second network device having installed thereon the application, wherein the profile specific information is stored at a cloud computing environment; determining an identification of the first network device to achieve a determined identification; comparing the determined identification to a set of user identities stored at the cloud computing environment; and based on the comparing, if the determined identification matches at least a portion of the set of user identities, then allowing access to the profile specific information.

### CROSS-REFERENCE TO RELATED APPLICATIONS

This application claims priority to and benefit of co-pending U.S. patent application Ser. No. ______ filed on ______ entitled “ACCOUNT ACCESS AUTHORIZER”, by Diego Besprosvan, having Attorney Docket No. TNGO-037A, and assigned to the assignee of the present application.

This application claims priority to and benefit of co-pending U.S. patent application Ser. No. ______ filed on ______ entitled “NETWORK COMMUNICATION SYSTEM”, by Diego Besprosvan, having Attorney Docket No. TNGO-037C, and assigned to the assignee of the present application.

### BACKGROUND

Conventionally, a computer application is downloaded and stored on a user's device (“first device”), such as a user's mobile phone. The application communicates with a server that services the application (e.g., updates, storing application user related activities, etc.). In order to connect to the user's account from another device (“second device”), wherein the user's account is located at the application server, the user must perform tedious steps while connected with the application server in order to revalidate his credentials. Once the application server determines that the second device has the authority to access the user's account connected with the first device, the application server releases the user's information to the second device. Thus, every time that a user attempts to access his account from a device that is different from his initially registered device, the user must perform undesirable time-consuming steps to revalidate his credentials.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a block diagram that illustrates a high level view of an example operation of an embodiment of the present technology.

FIG. 2 is a block diagram that illustrates an example application service provider computing environment and an example account access authorizer upon which an embodiment may operate.

FIGS. 3A and 3B are a flow diagram of an example method for authorizing access to an application account, thereby enabling seamlessly linking multiple network-connected devices to a same user application account, according to an embodiment.

FIG. 4 is a block diagram that illustrates an example cloud computing environment and an example account information releaser upon which an embodiment may operate.

FIG. 5 is a flow diagram of an example method for releasing account information to a network device, according to an embodiment.

FIG. 6 is a block diagram that illustrates an example network communication device and an example network communication system upon which an embodiment may operate.

FIGS. 7A and 7B are a flow diagram of an example method for seamlessly linking multiple network-connected devices to a same application account, according to an embodiment.

FIG. 8 is a block diagram of an example computer system with which or upon which various embodiments of the present invention may be implemented.

### DESCRIPTION OF EMBODIMENTS

Reference will now be made in detail to various embodiments, examples of which are illustrated in the accompanying drawings. While various embodiments are discussed herein, it will be understood that they are not intended to be limiting. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding. However, embodiments may be practiced without one or more of these specific details. In other instances, well known methods, procedures, components, and circuits have not been described in detail as not to unnecessarily obscure aspects of the described embodiments.

### Notation and Nomenclature

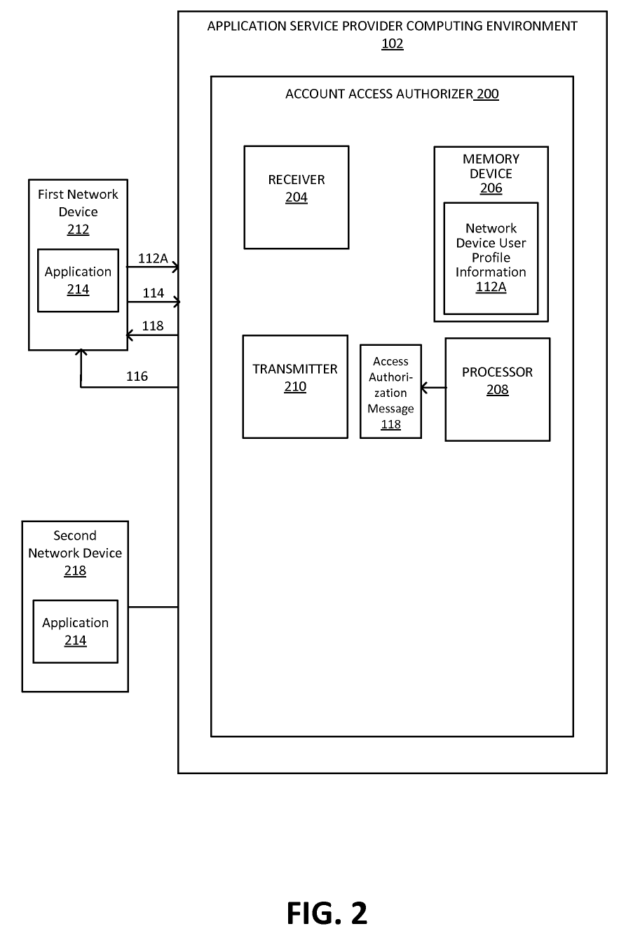

Unless specifically stated otherwise as apparent from the following discussions, it is appreciated that throughout the present Description of Embodiments, discussions utilizing terms such as “receiving”, “accessing”, “comparing”, “generating”, “monitoring”, “connecting”, “communicating”, “accessing”, “retrieving”, “generating”, “transmitting”, or the like, often refer to the actions and processes of an electronic computing device (or portion thereof), module or system, such as, but not limited to, an account access authorizer, account information releaser and a network communication system (See FIGS. 2, 4, 6). The electronic computing device/module/system transmits, receives, stores, manipulates and/or transforms signals represented as physical (electrical) quantities within the circuits, components, logic, and the like, of the electronic computing device/system into other signals similarly represented as physical electrical quantities within the electronic computing device/system or within or transmitted to other electronic computing devices/systems.

### Overview of Discussion

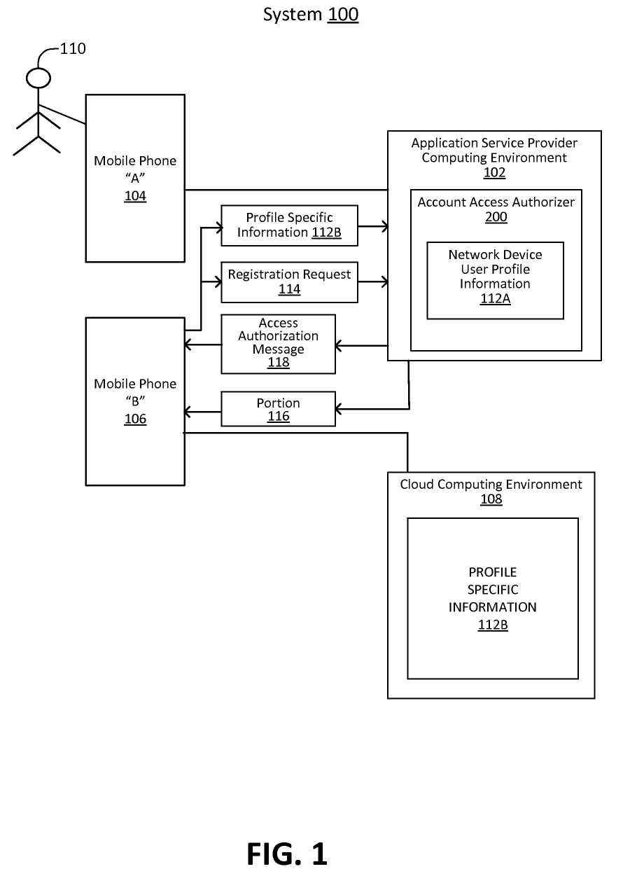

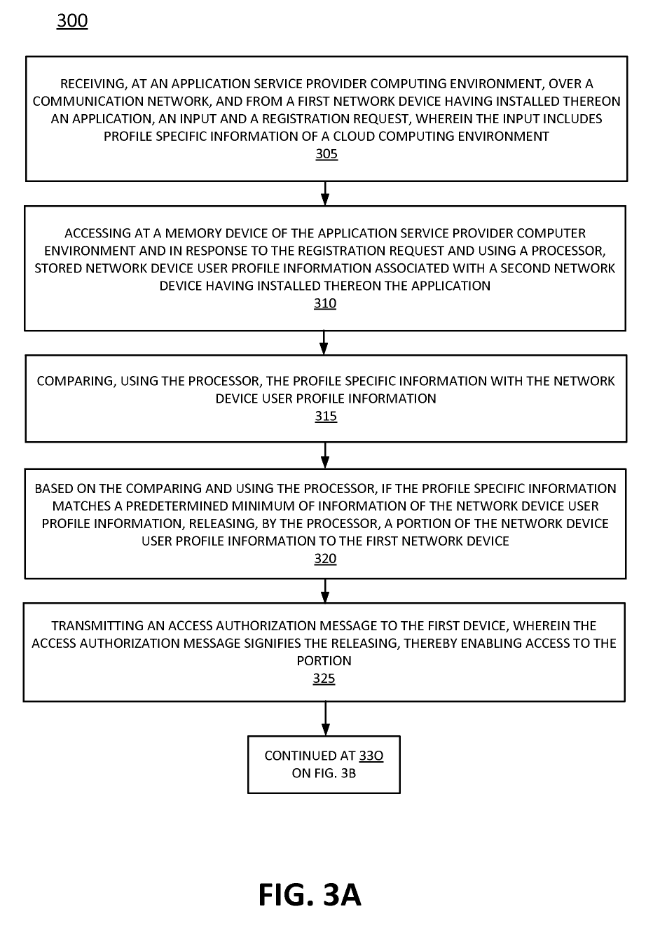

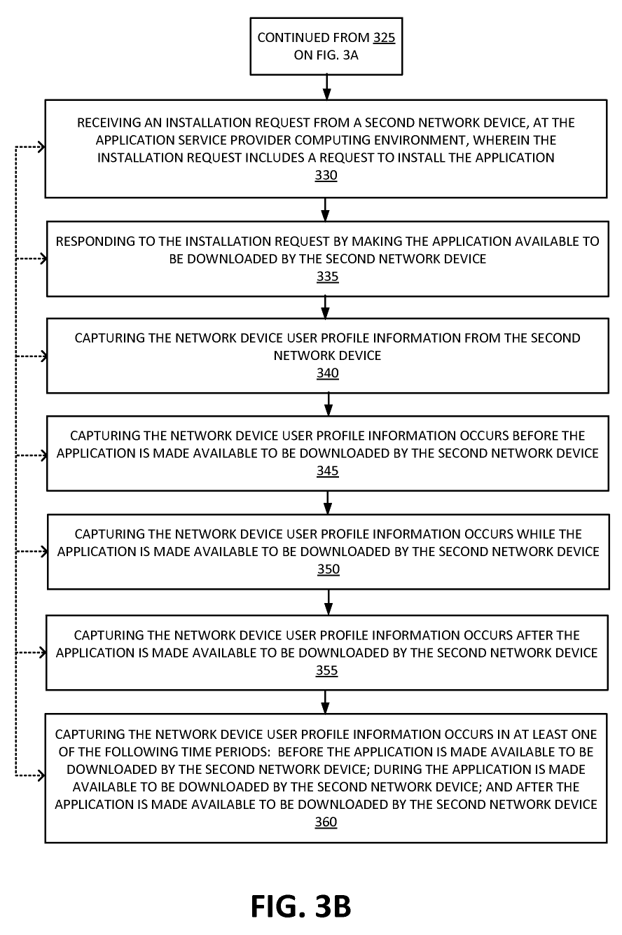

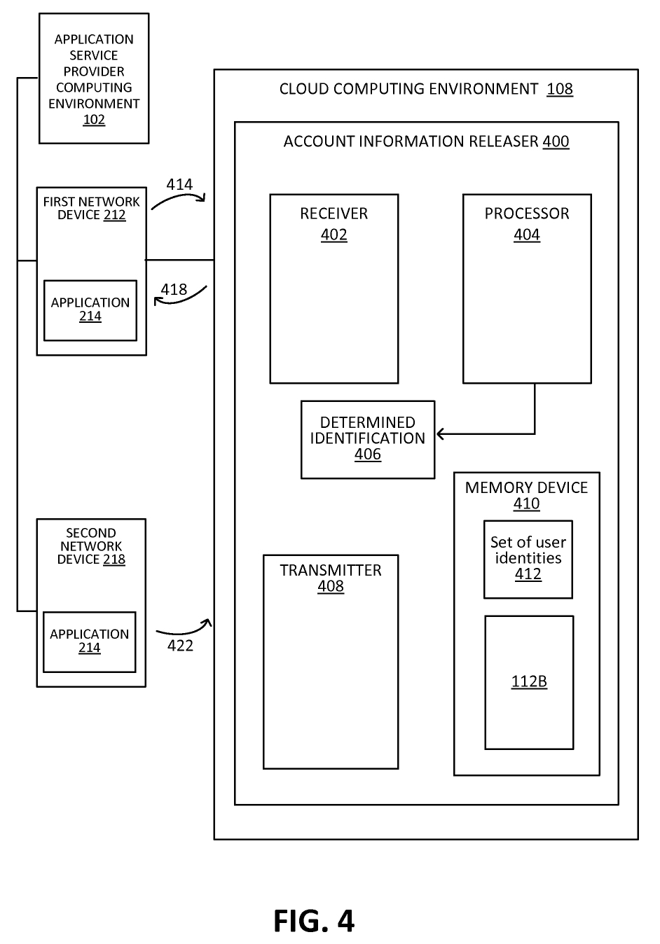

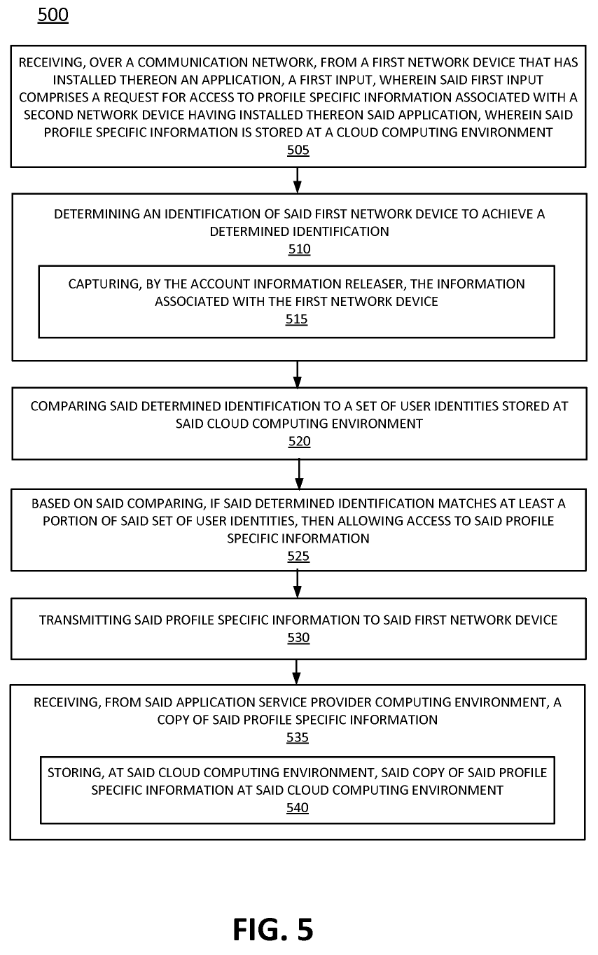

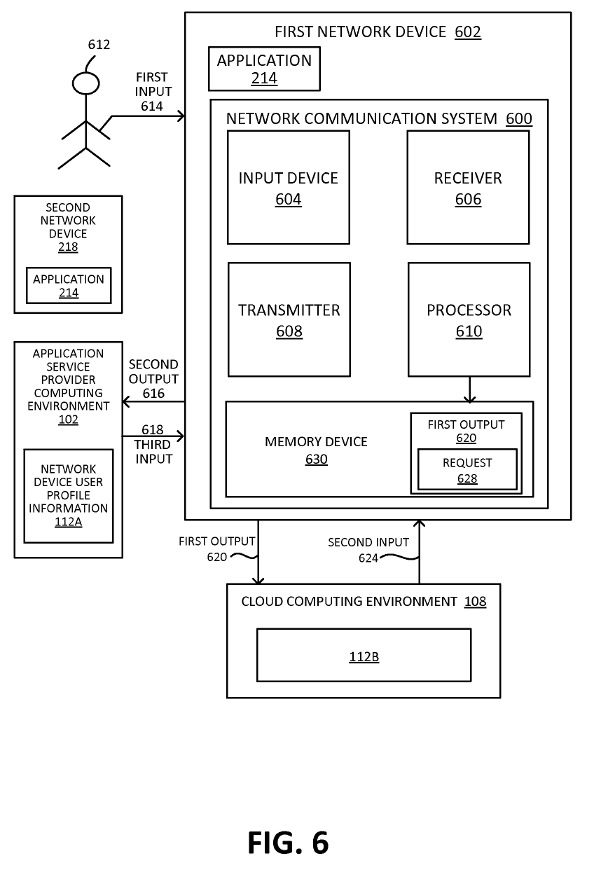

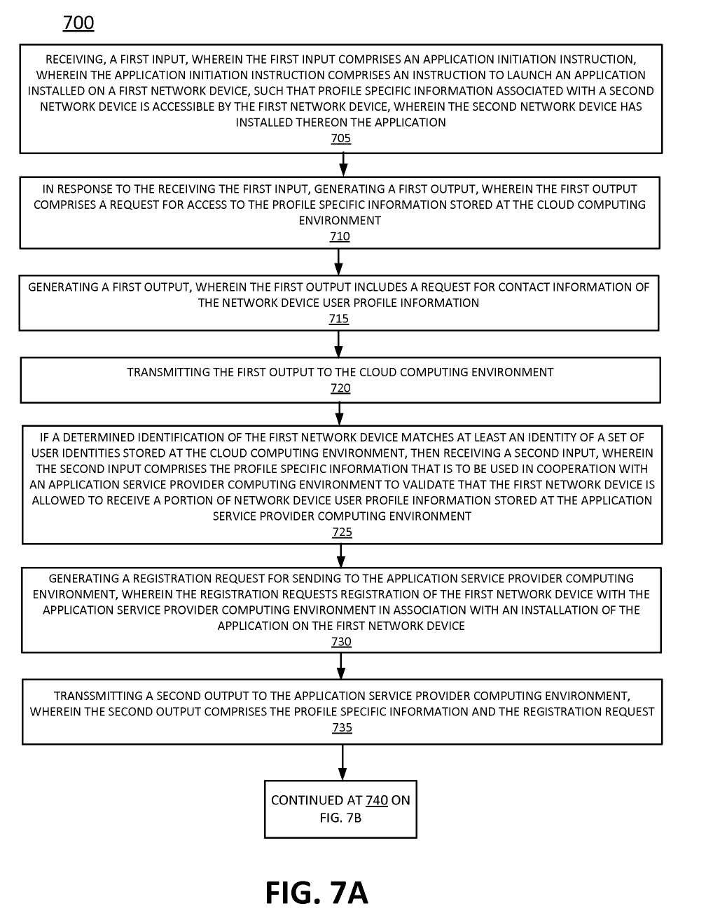

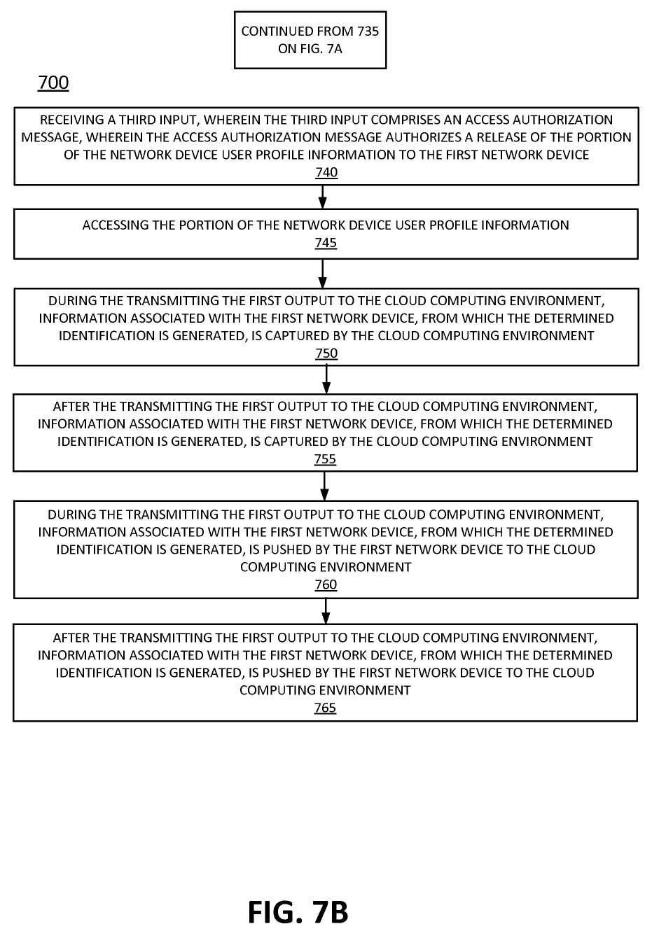

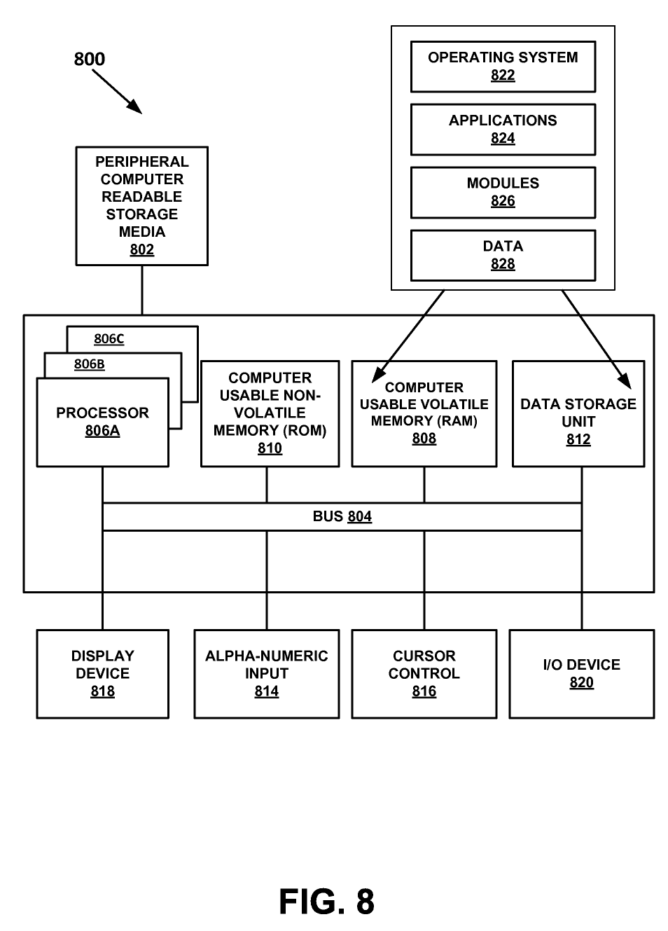

The discussion below begins with a brief description of conventional technology and the problems associated therewith. The discussion then turns to a description of FIG. 1, a high level view of a system 100 and method for seamlessly linking multiple network-connected devices to a single application account, in accordance with an embodiment. The discussion continues with description of an example account access authorizer located on an application service provider computing environment for authorizing access to an application account, thereby enabling seamlessly linking multiple network-connected devices to a same application account and a method thereof, in accordance with embodiments. (See FIGS. 2 and 3A and 3B.) The discussion then turns to a description of an example account information releaser located at a cloud computing environment for selectively releasing account information to a network communication device, thereby enabling seamlessly linking multiple network-connected devices to a same application account and a method thereof. (See FIGS. 4 and 5.) The discussion continues with a description of an example network communication system for processing an application launching request and channeling network communication between computing environments, thereby enabling seamlessly linking multiple network-connected devices to a same application account and a method thereof. (See FIGS. 6 and 7A and 7B.) Finally, the discussion concludes with a description of an example computer system upon which the example account access authorizer 200, the example account information releaser 400 and the example network communication system 600 and the example methods described herein operate. (See FIG. 8.)

Conventionally, a computer application is downloaded and stored on a user's device (“first device”), such as a user's mobile phone. The application communicates with a server that services the application (e.g., updates, storing application user related activities, etc.). In order to connect another device (“second” device) with the user's account and therefore have access to the user's account via the second device (when the user's account is located at the application server), the user must revalidate his credentials by performing tedious registration steps. Once the application server determines that the user of the second device has the authority to access the user's account, the application server releases the user's information to the second device. Thus, every time that the user attempts to access his account from a device that is different from his initially registered device, the user must perform undesirable time-consuming registration steps to revalidate his credentials.

Embodiments of the present technology resolve at least the aforementioned limitations of the conventional technology. In general, and as will be explained with reference to FIG. 1, embodiments enable multiple network connected devices to be linked to the same application account and access the account information (user contacts, etc.), without the user of the network-connected devices having to revalidate his credentials.

FIG. 1 is a high level example of an implementation of an embodiment of a system 100 and method for seamlessly linking multiple network-connected devices to a single application account, in accordance with an embodiment. The system 100 includes one or more network communication devices (e.g., mobile phone “A” 104, mobile phone “B” 106, etc.), an application service provider computing environment 102 and a cloud computing environment 108, all of which are configured to communicate with each other. When the user 110 of the mobile phone “A” 104 installs an application “T” (e.g., Tango) on mobile phone “A” 104, the application service provider computing environment 102, from which the user 110 downloaded the application, stores the user's 110 network device user profile information 112A at the application service provider computing environment 102. The user's 110 network device user profile information 112A includes the information that the user 110 provides to the application service provider computing environment 102 prior to downloading the application. The user's 110 network device user profile information 112A may also include information that the application service provider computing environment 102 gathers from the user's 110 network communication device (e.g., mobile phone “A” 104) during and/or after the download of the application occurs. The user's 110 network device user profile information 112A may include, but is not limited to being, the following types of information: name(s) of an authorized user(s) of the network communication device; password(s); phone number associated with network communication device; and information stored on the network communication device (e.g., contacts, emails, texts, search history, passwords for various applications, application game history, etc.).

In one embodiment, the mobile phone “A” 104 also has already sent or sends and/or updates the cloud computing environment 108 with profile specific information 112B of the network device user profile information 112A of the user 110. The profile specific information 112B is a portion of the network device user profile information 112A, wherein the portion may be the whole of or a portion less than the whole of the network device user profile information 112A. The cloud computing environment 108 stores this profile specific information 112B at the cloud computing environment 108.

In one embodiment, when a second device, such as mobile phone “B” 106 is set up, the credential for logging into the cloud computing environment 108 through the mobile phone “B” is established. Thus, when the user 110 of the mobile device “B” 106 logs into the cloud computing environment 108, this login process is transparent for the user 110.

In one embodiment, when the mobile phone “B” 106 starts the application “T”, the mobile phone “B” 106 automatically logs into the cloud computing environment 108 and then accesses the profile specific information 112B at the cloud computing environment 108.

The mobile phone “B” 106 accesses profile specific information 112B and then transmits it, along with a registration request 114 to the application service provider computing environment 102. The application service provider computing environment 102 receives this profile specific information 112B and the registration request 114. The application service provider computer environment 102 compares it to the network device user profile information 112A that is stored at the application service provider computing environment 102.

If the application service provider computing environment 102 determines that the profile specific information 112B is the same as information found within the network device user profile information 112A stored at the application service provider computing environment 102, then the application service provider computing environment 102 authorizes a release of a portion 116 of the network device user profile information 112A; this particular released portion may be the whole of the network device user profile information 112A or a portion thereof.

Thus, as discussed, when accessing the account information of mobile phone “A” 104 via mobile phone “B”, the user 110 did not have to re-enter personal information or register the mobile phone “B” in order to get the account information (e.g., contact list, etc.) of mobile phone “A” 104. Further, and significantly, the application service provider computing environment 102 does not have to communicate with the cloud computing environment 108 in order for the mobile phone “B” to be granted access to account information of the network device user profile information 112A.

A more detailed description of the system 100 for seamlessly linking multiple network-connected devices to a same application account follows in the following sections: SECTION 1) Account Access Authorizer; SECTION 2) Account Information Releaser; and SECTION 3) Network Communication System.

### Section One: Example Account Access Authorizer

FIG. 2 depicts the application service provider computing environment 102 coupled with a first network device 212, according to an embodiment. The application service provider computing environment 102 includes the account access authorizer 200, according to an embodiment. The account access authorizer 200 includes: a receiver 204; a memory device 206; a processor 208; and a transmitter 210.

The receiver 204 receives an input 216 and a registration request 114, at the account access authorizer 200, over a communication network, from a first network device 212 having installed thereon an application 214. The input 216 is in the form of a signal or data received by the account access authorizer 200. The input 216 includes the profile specific information of the cloud computing environment 108.

When the application 214 is installed on the second network device 218, such as the mobile phone “A” 104, the application service provider computing environment 102 accesses the network device user profile information 112A of the second network device 218 and stores it at the application service provider computing environment. Additionally, the application service provider computing environment communicates at least a portion, profile specific information 112B, of this network device user profile information 112A to the cloud computing environment 108. The cloud computing environment 108 stores this profile specific information 112B. This profile specific information 112B is later used to identify the user 110 of the first network device 212 as being the same user as the second network device 218, as will be described herein.

Of note, the application service provider computing environment 102 supports the application 214. By stating the application service provider computing environment 102 supports the application 214, it is meant to indicate that the application service provider computing environment 102 enables a computer program to handle all application operations between users and an organization's backend business applications or databases. Further, in one embodiment, the first network device 212 is the mobile phone “B” 106 and the second network device 218 is the mobile phone “A” described above with reference to the high level example of an embodiment of the present technology.

When the first network device 112, such as mobile phone “B” 106, is set up, a login credential is established for the first network device 112 as to the cloud computing environment 108. Thus, when the first network device 212 attempts to install the application 214, the first network device 212 automatically communicates with the cloud computing environment 108, using the established login credential, to retrieve the profile specific information112B.

The registration request 114 is a request from the first network device 212, such as mobile phone “B” 106, for at least a portion of the network device user profile information 112A, such as, for example, the user contact list associated with the second network device 218.

In one embodiment, the receiver 204 is also configured for receiving an installation request from the second network device 218. This installation request includes a request from the second network device 218 for installation of the application 214. In one embodiment, the account access authorizer 200 responds to this installation request by making the application 214 available to be downloaded by the second network device 218. By making the application 214 available to be downloaded, it is meant that the account access authorizer 200 either enables the second network device 218 to access the application 214 that is on the application service provider computing environment 102, or the account access authorizer 200 pushes the application 214 to the second network device 218. In one embodiment, the processor 208 of the account access authorizer 200 captures the network device user profile information 112A that originates on the second network device 218. The term “capturing” in this context describes the act of accessing the network device user profile information 112A and storing it at the memory device 206. The network device user profile information 112A may either pushed by the second network device 218 to the account access authorizer 200 or it may be pulled from the second network device 218 by the account access authorizer 200. Either way, the account access authorizer 200 acquires the network device user profile information 112A and stores it at the memory device 206. In one embodiment, the network device user profile information 112A is captured before the application 214 is made available to be downloaded by the second network device 214. In another embodiment, the network device user profile information 112A is captured while the application 214 is made available to be downloaded by the second network device 214. In another embodiment, the network device user profile information 112A is captured after the application 214 is made available to be downloaded by the second network device 214. In yet another embodiment, the network device user profile information 112A is captured during at least one of the following time periods: before the application 214 is made available to be downloaded by the second network device 214; while the application 214 is made available to be downloaded by the second network device 214; and after the application 214 is made available to be downloaded by the second network device 214.

The memory device 206 stores thereon network device user profile information 112A. The network device user profile information 112A is associated with a second network device 218. As noted, the second network device 218 has installed thereon the application 214.

The processor 208 performs at least the following three operations: 1) the processor 208 accesses the profile specific information 112B at the second network device 218 (In one embodiment, this accessing is performed by a network device profile specific information accessor module [see FIG. 8, modules 826]) and accesses the registration request 114 sent by the first network device 218 to the application service provider computing environment 102 (In one embodiment, this accessing of the registration request 114 is performed by a network device registration request accessor module [see FIG. 8, modules 826]); 2) the processor 208 compares the profile specific information 112B with the network device user profile information 112A (In one embodiment, this comparing is performed by a comparer module [see FIG. 8, modules 826]); and 3) based on the comparing performed at step (2), if the “first” portion 116 profile specific information 112B matches a predetermined minimum of information of the network device user profile information 112A, the processor 208 releases a portion 116 of the network device user profile information 112A to the first network device (In one embodiment, the release of the portion 116 of the network device user profile information 112A performed by an authorization message generator module [see FIG. 8, modules 826]). For example but not limited to such example, in one embodiment, the “predetermined minimum of information” that is required to be matched before the processor 208 release the portion 116 of the network device user profile information 112A may be that of, 1) a user name relating to the second network device 218; and 2) a user password relating to the second network device 218. It should be noted that the matched information may be any information that was gathered by the application service provider computing environment 102 when registering the second network device 218, wherein this gathered information was stored at the application service provider computing environment 102 as network device user profile information 112A. The portion 116 of the network device user profile information 112A that is released is a predetermined amount of information to be released, such as, but not limited to being, contact information associated with the first network device 212, credit card account information stored on the first network device and associated with the user 110 of the first network device 212, etc. The amount of information (portion 116) that is released is determined either at the factory, by the manager of the application service provider computing environment 102, or the user 110 (in association with installing the application 214 on the second network device 214 or at some point in time thereafter). As described herein, the profile specific information 112B is sent to the cloud computing environment 108. The cloud computing environment 108 stores this copy of the profile specific information 112B. (In one embodiment, a storage module stores the copy of the profile specific information 112B [see FIG. 8, modules 826]). Thus, after the profile specific information 112B and the registration request 114 are sent by the first network device 212 to the application service provider computing environment 102, the application service provider computing environment 102 compares this profile specific information 112B to the network device user profile information 112A. If a “match” results, then the application service provider computing environment 102 releases the portion 116 of the network device user profile information 112A to the first network device 212; the first network device 212 can access the portion 116 after the “release”.

The transmitter 210 transmits an access authorization message 118, via a data signal, to the first network device 212. The access authorization message 118 signifies the release of the portion 116 of the network device user profile information 112A, such that the first network device 212 is able to access the portion 116. The access authorization message 118 acts as a trigger for the first network device 212 to access the portion 116.

### Example Operation of Method for Authorizing Access to an Application Account

The following discussion sets forth in detail some example methods of operation of embodiments. With reference to FIGS. 3A and 3B, the flow diagram of method 300 illustrates an example procedure used by various embodiments for authorizing access to an application account, thereby enabling seamlessly linking multiple network-connected devices to a same user account. Method 300 includes some procedures that, in various embodiments, all or a portion of all are carried out by a processor under the control of computer-readable and computer-executable instructions which reside, for example, on any tangible computer-usable/readable media. In various embodiments, these computer-readable and computer-executable instructions are described as “code segments”, and presented separately (e.g., first codes segment, second code segment, etc.) to describe such instructions. In this fashion, procedures described herein and in conjunction with these flow diagrams, alone or in combination, are, or may be, implemented using a computer, in various embodiments. Some non-limiting examples of tangible computer readable storage media include random access memory, read only memory, magnetic disks, and optical disks, solid-state disks, any or all of which may be employed within a virtualization infrastructure. The computer-readable and computer-executable instructions, which reside on tangible computer readable storage media, are used to control or operate in conjunction with, for example, one or some combination of processors of a virtual machine. It is appreciated that the processor(s) may be physical or virtual or some combination (it should also be appreciated that a virtual processor is implemented on physical hardware). Although specific procedures are disclosed in method 300, such procedures are examples. That is, embodiments are well suited to performing various other procedures or variations of the procedures recited in method 300, alone or in combination. Likewise, in some embodiments, the procedures in method 300, alone or in combination, may be performed in an order different than presented and/or not all of the procedures described in one or more of these flow diagrams may be performed. It is further appreciated that procedures described in method 300, alone or in combination, may be implemented in hardware, or a combination of hardware with firmware and/or software.

With reference to FIGS. 1-3A, at step 305 of method 300, in one embodiment and as described herein, the input and the registration request 114 is received, at the application service provider computing environment 102, over a communication network, and from the first network device 212 having installed thereon the application 214. The input includes the profile specific information 112B of the cloud computing environment 108 (or more specifically, a copy of the profile specific information 112B)

With reference to FIGS. 1-3A, at step 310 of method 300, in one embodiment and as described herein, in response to the registration request 114, the stored network device user profile information 112A associated with the second network device 218 having installed thereon the application 214 is accessed at the memory device 206, using the processor 208.

With reference to FIGS. 1-3A, at step 315 of method 300, in one embodiment and as described herein, the profile specific information 112B of the cloud computing environment user profile information 112B is compared, using the processor 208, with the network device user profile information 112A.

With reference to FIGS. 1-3A, at step 320 of method 300, in one embodiment and as described herein, based on the comparing performed at step 315 and using the processor 208, if the profile specific information 112B of the cloud computing environment user profile information 112B matches a predetermined minimum of information of the network device user profile information 112A, the portion 116 of the network device user profile information is released to the first network device 212. As noted above, in one embodiment, the first network device is the mobile phone “B” 106 and the second network device 218 is the mobile phone “A” 104 described above.

With reference to FIGS. 1-3A, at step 325 of method 300, in one embodiment and as described herein, an access authorization message 118 is transmitted, by the application service provider computing environment 102 to the first network device 212. The access authorization message 118 signifies the releasing of step 320, thereby enabling access to the portion 116.

With reference to FIGS. 1-3B, at step 330 of method 300, in one embodiment and as described herein, an installation request is received from the second network device 218, at the application service provider computing environment 102, wherein the installation request includes a request to install the application 214.

With reference to FIGS. 1-3B, at step 335 of method 300, in one embodiment and as described herein, a response to the installation request made at step 330 by making the application 214 available to be downloaded by the second network device 218.

With reference to FIGS. 1-3B, at step 340 of method 300, in one embodiment and as described herein, the network device user profile information 112A is captured from the second network device 218.

With reference to FIGS. 1-3B, at step 345 of method 300, in one embodiment and as described herein, the capture of the network device user profile information 112A performed at step 340 occurs before the application 214 is made available to be downloaded by the second network device 218.

With reference to FIGS. 1-3B, at step 350, in one embodiment and as described herein, the capture of the network device user profile information 112A performed at step 340 occurs while the application 214 is made available to be downloaded by the second network device 218.

With reference to FIGS. 1-3B, at step 355, in one embodiment and as described herein, the capture of the network device user profile information 112A performed at step 340 occurs after the application 214 is made available to be downloaded by the second network device 218.

With reference to FIGS. 1-3B, at step 360, in one embodiment and as described herein, the capture of the network device user profile information 112A performed at step 340 occurs in at least one of the following time periods: before the application 214 is made available to be downloaded by the second network device 218; while the application 214 is made available to be downloaded by the second network device 218; and after the application 214 is made available to be downloaded by the second network device 218.

Thus, embodiments provide a system and method for enabling a user to access his user account information from a different network-connected device than the device with which he registered with an application service provider (while installing the application) without having to manually repeat registration steps or “log-in” to his account. The user of the network-connected devices does not experience delays during such a process. Thus, embodiments of the present technology enable seamlessly linking multiple network-connected devices to a same user application account. Further, of note, embodiments function without communication between the application service provider and the cloud server.

### Section Two: Example Account Information Releaser

FIG. 4 depicts the cloud computing environment 108 coupled with the first network device 212, according to an embodiment. The cloud computing environment 108 includes the account information releaser 400, according to an embodiment. The account information releaser 400 includes: a receiver 402; a processor 404, a transmitter 408 and a memory device 410.

The receiver 402 receives a first input 414. The first input 414 is received, over a communication network, from said first network device 212 that has installed thereon the application 214. The first input 414 includes a request for access to profile specific information 112B (that is associated with the second network device 218 that also has installed thereon the application 214). The profile specific information 112B is stored at the cloud computing environment 108. The request may result in a release of the profile specific information 112B to the first network device 212.

In one embodiment, the receiver 402 further receives, from the second network device 218, a second input 422. The second input 422 includes a copy of the profile specific information 112B. For example, the second network device 218 registers with/provides requested information to the application server provider computing environment 102 in order to download the application 214 onto the second network device 218. The application service provider computing environment 102 collects information from the second network device 218 and/or receives particular information from the second network device 218. The application service provider computing environment 102 then stores this information, which it collected and/or received, at its memory device 206 (see FIG. 2). The cloud computing environment 108 stores this received profile specific information 112B at the memory device 410.

In another embodiment, the second input 422 (including the copy of the profile specific information 112B) includes a user identity 412 associated with the second network device 218. The user identity 412 is stored along with the set of user identities 416 that is stored at the memory device 410 of the cloud computing environment 108. The user identity 412 may be any information that aids in identifying the second network device 218. For example, information of the user identity 412 may be, but is not limited to being, the user of the second network device 218's username and/or password.

Of note, the first input 414 and the second input 422 are in the form of a signal or data received by the account information releaser 400.

The processor 404 determines an identification of the first network device 212 to achieve a determined identification 406. (In one embodiment, the determining of the identification of the first network device 212 is performed by an identification determiner module [see FIG. 8, modules 826]). Thus, when the first network device 212 sends a first input 414 to the account information releaser 400, requesting access to the profile specific information 112B, the processor 404 determines some identifying information about the first network device 212. For example, this identifying information may be, but is not limited to being, the username and/or password for the first network device 212. In one embodiment, the account information releaser 400 captures information associated with the first network device 212. In other words, the account information releaser 400 accesses the first network device 212 and pulls from the first network device 212 information regarding its identification. In another embodiment, the first network device 212 sends identifying information to the account information releaser 400. Thus, from this accessed and/or sent information, the account information releaser 400 is able to determine an identification of the first network device 212.

The processor 404 then compares this determined identification 406 of the first network device 212 to the set of user identities 416 that is stored at the cloud computing environment 108, at the memory device 410. (In one embodiment, the comparing the determined identification 406 to the set of user identities 416 is performed by a determined identification comparing module [see FIG. 8, modules 826]).

Based on the comparing performed, if the determined identification 406 matches an identity of the set of user identities 416, then the processor 404 allows access to the profile specific information 112B that is to be received by the application service provider computing environment 102 (in combination with the registration request 114 discussed herein) such as to allow the first network device 212 to have access to the portion 116 of the network device user profile information 112A. The first network device 212 desires access of the network device user profile information 112A of the application service provider computing environment 102, or the portion 116 thereof. However, until the application service provider computing environment 102 actually receives the profile specific information 112B and the registration request 114, this profile specific information 112B will not be released to the first network device 212. Of significance, embodiments enable the first network device 212 to access the user profile information (e.g., user contacts, account information, etc.) of the second network device 218 without the need for the cloud computing environment 108 to communicate with the application service provider computing environment 102.

The transmitter 408 transmits the first output 418 to the first network device 212. The first output 418 that is transmitted includes the profile specific information 112B.

The memory device 410 stores the profile specific information 112B, wherein the memory device 410 is located at the cloud computing environment 108. A copy of the information representing the set of user identities 416 may also be stored separate from the cloud computing environment 108 and at the memory device 410, as in one embodiment, the memory device 410 is remote from the cloud computing environment 108 but communicatively coupled therewith via wire and/or wirelessly.

### Example Operation of Method for Releasing Account Information to a Network Device

The following discussion sets forth in detail some example methods of operation of embodiments. With reference to FIG. 5, the flow diagram of method 500 illustrates an example procedure used by various embodiments for releasing account information to a network-connected device. Method 500 includes some procedures that, in various embodiments, all or a portion of all are carried out by a processor under the control of computer-readable and computer-executable instructions which reside, for example, on any tangible computer-usable/readable media. In various embodiments, these computer-readable and computer-executable instructions are described as “code segments”, and presented separately (e.g., first code segment, second code segment, etc.) to describe such instructions. In this fashion, procedures described herein and in conjunction with these flow diagrams, alone or in combination, are, or may be, implemented using a computer, in various embodiments. Some non-limiting examples of tangible computer readable storage media include random access memory, read only memory, magnetic disks, and optical disks, solid-state disks, any or all of which may be employed within a virtualization infrastructure. The computer-readable and computer-executable instructions, which reside on tangible computer readable storage media, are used to control or operate in conjunction with, for example, one or some combination of processors of a virtual machine. It is appreciated that the processor(s) may be physical or virtual or some combination (it should also be appreciated that a virtual processor is implemented on physical hardware). Although specific procedures are disclosed in method 500, such procedures are examples. That is, embodiments are well suited to performing various other procedures or variations of the procedures recited in method 500, alone or in combination. Likewise, in some embodiments, the procedures in method 500, alone or in combination, may be performed in an order different than presented and/or not all of the procedures described in one or more of these flow diagrams may be performed. It is further appreciated that procedures described in method 500, alone or in combination, may be implemented in hardware, or a combination of hardware with firmware and/or software.

With reference to FIGS. 1-5, at step 505 of method 500, in one embodiment and as described herein, the first input 414 is received, over a communication network, from the first network device 212 that has installed thereon the application 214, the first input 414, wherein the first input 414 includes a request for access to the profile specific information 112B associated with the second network device 218 having installed thereon the application 214. The profile specific information 112B is stored at the cloud computing environment 108.

With reference to FIGS. 1-5, at step 510 of method 500, in one embodiment and as described herein, an identification of the first network device 212 is determined to achieve the determined identification 406. With reference to FIGS. 1-5, at step 515, in one embodiment and as described herein, the information associated with the first network device 212 is captured by the account information releaser 400, which is in addition to, or instead of, being pushed to the account information releaser 400 by the first network device 212. For example, once this information associated with the first network device 212 is captured and/or accessed, the account information releaser 400 is enabled to generate the determined identification 406.

With reference to FIGS. 1-5, at step 520 of method 500, in one embodiment and as described herein, the determined identification 406 is compared to the set of user identities 416 stored at the cloud computing environment 108.

With reference to FIGS. 1-5, at step 525 of method 500, in one embodiment and as described herein, based on the comparing performed at step 514 and using the processor 404, if the determined identification 406 matches at least a portion of the set of user identities 416, then profile specific information 112B is released to the first network device 212. As noted above, in one embodiment, the first network device 212 is the mobile phone “B” 106 and the second network device 218 is the mobile phone “A” 104 described above.

With reference to FIGS. 1-5, at step 530 of method 500, in one embodiment and as described herein, the first output 418 is transmitted to the first network device 212, wherein the first output 418 includes the “profile specific information 112B. In one embodiment, the first output 418 is transmitted in the form of a data signal.

With reference to FIGS. 1-5, at step 535 of method 500, in one embodiment and as described herein, the second input 422 is received from the first network device 212. The second input 422 includes a copy of the profile specific information 112B. In one embodiment, the copy of the profile specific information 112B includes a user identity of the second network device 218. In one embodiment, the second input 422 received in the form of a data signal. In another embodiment and as described herein the receiving performed at step 530 includes the step 540 of storing, at the cloud computing environment 108, the copy of the profile specific information 112B. In one embodiment, the copy of the network device user profile information 112A is received in the form of a data signal.

Thus, embodiments of the account information releaser 400 enables a secure method by which the user of the first network device 212 may validly receive at that first network device 212 the user's account information that is associated with a different, second network device 218. Thus, embodiments of the present technology enable seamlessly linking multiple network-connected devices to a same user application account.

### Section Three: Example Network Communication System

FIG. 6 depicts the first network device 602 having thereon the network communication system 600, according to an embodiment. The network communication system 600 includes: an input device 604; a receiver 606; a transmitter 608; and a processor 610. In one embodiment, the first network device 602, is the mobile phone “A” 104. In another embodiment, the first network device 602 is mobile phone “B” 106 (and the second network device 218 is mobile phone “A” 104). It should be understood that that first network device 602 may be any device that is capable of communicating over a network.

The input device 604 receives a first input 614, wherein the first input 614 includes an application initiation instruction. The application initiation instruction includes an instruction to launch the application 214 installed on the first network device 602, such that network device user profile information 112A associated with the second network device 218 is accessible by the first network device 602 (the second network device 218 also has installed thereon the application 214). In one embodiment, the input device 604 is the I/O device 820 shown in the computer system 800 described with respect to FIG. 8 below. The user 612 uses the input device 604 to enter his application initiation instruction. The application initiation instruction requests that the application 214 be launched, such that the user and various components of the first network device 602 may engage with the application 214 that is running on the first network device 602, and that the user may access his account information (network device user profile information 112A or a portion 116 thereof) that is associated with a separate device. Conventionally, the user would have to interact with an application service provider to validate/login to his account from every device from which he wants to access his account. However, according to embodiments, the request to launch the application 214 initiates a series of transparent and seamless exchanges of information between the first network device 602 and the application service provider computing environment 102 and between the first network device 602 and the cloud computing environment 108. During these exchanges, the user 612 of the first network device 602 does not participate. Thus, the user 612 is not required to engage with out of band verification mechanisms like SMS or email to manually validate/login to his account.

The processor 610, in response to the network communication system 600 receiving the first input 614, generates a first output 620, wherein the first output 620 includes a request 628, which is a request 628 for access to a copy of the profile specific information 112B that is stored at the cloud computing environment 108. In one embodiment, the first output 620 includes a request 628, which is a request for contact information (information relating to “contacts” stored at the application service provider computing environment 102). Of note, in various embodiments, the request 628 may be for any particular type or amount of information that is part of the network device user profile information 112A. (In one embodiment, the generation of the first output 620 is performed by a first output generator module [see FIG. 8, modules 826]).

The transmitter 608 transmits the first output 620 (request 628 for access to a copy of the profile specific information 112B) to the cloud computing environment 108. In one embodiment, during the transmitting of the first output 620 to the cloud computing environment 108, information associated with the first network device 602, from which the determined identification 406 is generated, is captured by the cloud computing environment 108. In another embodiment, after the transmitting of the first output 620 to the cloud computing environment 108, information associated with the first network device 602, from which the determined identification 406 is generated, is captured by the cloud computing environment 108. In one embodiment, during the transmitting of the first output 620 to the cloud computing environment 108, information associated with the first network device 602, from which the determined identification 406 is generated, is pushed to the cloud computing environment 108 by the first network device 602. In another embodiment, after the transmitting of the first output 620 to the cloud computing environment 108, information associated with the first network device 602, from which the determined identification 406 is generated, is pushed to the cloud computing environment 108 by the first network device 602. In one embodiment, the first output 620 is transmitted in the form of a data signal.

Next, if the determined identification 406 of the first network device 602 matches a user identity of the set of user identities 416 stored at the cloud computing environment 108, then the receiver 606 receives the second input 624. The second input 624 includes the profile specific information 112B that is to be used in cooperation with an application service provider computing environment 102 to validate that the first network device 602 is allowed to access the portion 116 of the profile specific information 112B that is stored at the application service provider computing environment 102.

Additionally, the processor 610 generates a registration request 114 for sending to the application service provider computing environment 102. The registration request 114 requests registration of the first network device 602 with the application service provider computing environment 102 in association with the launching of the application 214 installed on the first network device 602.

The transmitter 608 then transmits the second output 616 to the application service provider computing environment 102. The second output 616 includes the copy of the profile specific information 112B and the registration request 114. In one embodiment, the second output 616 is transmitted in the form of a data signal.

The receiver 606 also receives a third input 618. The third input 618 includes the access authorization message 118. As described herein, the access authorization message 118 authorizes a release of the portion 116 of the network device user profile information 112A to the first network device 602. In one embodiment, the third input 618 is received in the form of a data signal.

The transmitter 608 also transmits a third output 622 to the cloud computing environment 108, wherein the third output 622 includes the access authorization message 118. In one embodiment, the third output 622 is transmitted in the form of a data signal.

The processor 610 then accesses the portion 116 of the network device user profile information 112A.

Thus, the receiver 606 of the network communication system 600 is configured for receiving the first input 620, the second input 624, and the third input 618. The transmitter 608 of the network communication system 600 is configured for transmitting the first output 620 and the second output 616. The processor 610 is configured for generating the first output 620 and the second output 616.

The network communication system 600, in one embodiment, further includes a memory device 630. The memory device 630 stores the first input 620, the second input 624, the third input 618, the first output 616 and the second output 616.

Thus, embodiments enable the release of account information to a network device other than the originating network device without the need for the user of the new network device having to manually revalidate his credentials, thereby enabling a seamless linkage of multiple network-connected devices to the same user application account.

### Example Operation of a Method for Seamlessly Linking Multiple Network-Connected Devices to a Same Application Account

The following discussion sets forth in detail some example methods of operation of embodiments. With reference to FIGS. 7A and 7B, the flow diagram of method 700 illustrates an example procedure used by various embodiments for seamlessly linking multiple network-connected devices to a same application account. Method 700 includes some procedures that, in various embodiments, all or a portion of all are carried out by a processor under the control of computer-readable and computer-executable instructions which reside, for example, on any tangible computer-usable/readable media. In various embodiments, these computer-readable and computer-executable instructions are described as “code segments”, and presented separately (e.g., first code segment, second code segment, etc.) to describe such instructions. In this fashion, procedures described herein and in conjunction with these flow diagrams, alone or in combination, are, or may be, implemented using a computer, in various embodiments. Some non-limiting examples of tangible computer readable storage media include random access memory, read only memory, magnetic disks, and optical disks, solid-state disks, any or all of which may be employed within a virtualization infrastructure. The computer-readable and computer-executable instructions, which reside on tangible computer readable storage media, are used to control or operate in conjunction with, for example, one or some combination of processors of a virtual machine. It is appreciated that the processor(s) may be physical or virtual or some combination (it should also be appreciated that a virtual processor is implemented on physical hardware). Although specific procedures are disclosed in method 700, such procedures are examples. That is, embodiments are well suited to performing various other procedures or variations of the procedures recited in method 700, alone or in combination. Likewise, in some embodiments, the procedures in method 700, alone or in combination, may be performed in an order different than presented and/or not all of the procedures described in one or more of these flow diagrams may be performed. It is further appreciated that procedures described in method 700, alone or in combination, may be implemented in hardware, or a combination of hardware with firmware and/or software.

With reference to FIGS. 1-7A, at step 705 of method 700, in one embodiment and as described herein, the first input 614 is received. The first input 614 includes an application initiation instruction. The application initiation instruction includes an instruction to launch the application 214 installed on the first network device 212, such as the network communication device 602, such that the portion 116 of the network device user profile information 112A associated with the second network device 218 is accessible by the first network device 212, wherein the second network device 218 has installed thereon the application 214.

With reference to FIGS. 1-7A, at step 710 of method 700, in one embodiment and as described herein, in response to the receiving of the first input 614, the first output 620 is generated. The first output 620 includes a request for access to a copy of the profile specific information 112B stored at the cloud computing environment 108. In one embodiment and as described herein, in response to receiving the first input 614, at step 715, the first output 620 that is generated at step 710 includes a request for contact information of the network device user profile information 112A.

With reference to FIGS. 1-7A, at step 720 of method 700, in one embodiment and as described herein, the first output 620 is transmitted to the cloud computing environment 108.

With reference to FIGS. 1-7A, at step 725 of method 700, in one embodiment and as described herein, if the determined identification 406 of the first network device 212 matches at least an identity of the set of user identities 416 stored at the cloud computing environment 108, then the second input 624 is received. The second input 624 includes the profile specific information 112B that is to be used in cooperation with the application service provider computing environment 102 to validate that the first network device 212 is allowed to receive the portion 116 of the network device user profile information 112A.

With reference to FIGS. 1-7A, at step 730 of method 700, in one embodiment and as described herein, the registration request 114 is generated. The registration request 114 is to be sent to the application service provider computing environment 102. The registration request 114 requests registration of the first network device 602 with the application service provider computing environment 102 in association with the launching of the application 214 that is installed on the first network device 602.

With reference to FIGS. 1-7A, at step 735 of method 700, in one embodiment and as described herein, the second output 616 is transmitted to the application service provider computing environment 102. The second output 616 includes the copy of the profile specific information 112B and the registration request 114.

With reference to FIGS. 1-7B, at step 740 of method 700, in one embodiment and as described herein, the third input 618 is received. The third input 618 includes the access authorization message 118. The access authorization message 118 authorizes a release of the portion 116 of the network device user profile information 112A.

With reference to FIGS. 1-7B, at step 745 of method 500, in one embodiment and as described herein, the portion 116 of the network device user profile information 112A is accessed.

With reference to FIGS. 1-7B, at step 750, in one embodiment and as described herein, during the transmitting (performed at step 720) of the first output 620 to the cloud computing environment 108, information associated with the first network device 212, from which the determined identification 406 is generated, is captured by the cloud computing environment 108. In another embodiment and as described herein, at step 755, after the transmitting (performed at step 720) of the first output 620 to the cloud computing environment 108, information associated with the first network device 212, from which the determined identification 406 is generated, is captured by the cloud computing environment 108. In yet another embodiment and as described herein, at step 760, during the transmitting (performed at step 720) of the first output 620 to the cloud computing environment 108, information associated with the first network device 212, from which the determined identification 406 is generated, is pushed by the first network device 212 to the cloud computing environment 108. In another embodiment and as described herein, at step 765, after the transmitting (performed at step 720) of the first output 620 to the cloud computing environment 108, information associated with the first network device 212, from which the determined identification 406 is generated, is pushed by the first network device 212 to the cloud computing environment 108.

Thus, embodiments provide methods and systems for seamlessly linking multiple network-connected devices to a same application account.

### Example Computer System Environment

With reference now to FIG. 8, all or portions of some embodiments described herein are composed of computer-readable and computer-executable instructions that reside, for example, in computer-usable/computer-readable storage media of a computer system. That is, FIG. 8 illustrates one example of a type of computer (computer system 800) that can be used in accordance with or to implement various embodiments which are discussed herein. It is appreciated that computer system 800 of FIG. 8 is only an example and that embodiments as described herein can operate on or within a number of different computer systems including, but not limited to, general purpose networked computer systems, embedded computer systems, routers, switches, server devices, client devices, various intermediate devices/nodes, stand alone computer systems, distributed computer systems, media centers, handheld computer systems (including, but not limited to a mobile device, such as a mobile phone), multi-media devices, and the like. Computer system 800 of FIG. 8 is well adapted to having peripheral non-transitory computer-readable storage media 802 such as, for example, a floppy disk, a compact disc, digital versatile disc, other disc based storage, universal serial bus “thumb” drive, removable memory card, and the like coupled thereto.

System 800 of FIG. 8 includes an address/data bus 804 for communicating information, and a processor 806A coupled with bus 804 for processing information and instructions. As depicted in FIG. 8, system 800 is also well suited to a multi-processor environment in which a plurality of processors 806A, 806B, and 806C are present. Conversely, system 800 is also well suited to having a single processor such as, for example, processor 806A. Processors 806A, 806B, and 806C may be any of various types of microprocessors. System 800 also includes data storage features such as a computer usable volatile memory 808, e.g., random access memory (RAM), coupled with bus 804 for storing information and instructions for processors 806A, 806B, and 806C.

System 800 also includes computer usable non-volatile memory 810, e.g., read only memory (ROM), coupled with bus 804 for storing static information and instructions for processors 806A, 806B, and 806C. Also present in system 800 is a data storage unit 812 (e.g., a magnetic or optical disk and disk drive) coupled with bus 804 for storing information and instructions. System 800 also includes an optional alphanumeric input device 814 including alphanumeric and function keys coupled with bus 804 for communicating information and command selections to processor 806A or processors 806A, 806B, and 806C. System 800 also includes an optional cursor control device 816 coupled with bus 804 for communicating user input information and command selections to processor 806A or processors 806A, 806B, and 806C. In one embodiment, system 800 also includes an optional display device 818 coupled with bus 804 for displaying information.

Referring still to FIG. 8, optional display device 818 of FIG. 8 may be a liquid crystal device, cathode ray tube, plasma display device or other display device suitable for creating graphic images and alphanumeric characters recognizable to a user. Optional cursor control device 816 allows the computer user to dynamically signal the movement of a visible symbol (cursor) on a display screen of display device 818 and indicate user selections of selectable items displayed on display device 818. Many implementations of cursor control device 816 are known in the art including a trackball, mouse, touch pad, joystick or special keys on alphanumeric input device 814 capable of signaling movement of a given direction or manner of displacement. Alternatively, it will be appreciated that a cursor can be directed and/or activated via input from alphanumeric input device 814 using special keys and key sequence commands. System 800 is also well suited to having a cursor directed by other means such as, for example, voice commands. System 800 also includes an I/O device 820 for coupling system 800 with external entities. For example, in one embodiment, I/O device 820 is a modem for enabling wired or wireless communications between system 800 and an external network such as, but not limited to, the Internet.

Referring still to FIG. 8, various other components are depicted for system 800. Specifically, when present, an operating system 822, applications 824, modules 826, and data 828 are shown as typically residing in one or some combination of computer usable volatile memory 808 (e.g., RAM), computer usable non-volatile memory 810 (e.g., ROM), and data storage unit 812. In some embodiments, all or portions of various embodiments described herein are stored, for example, as an application 824 and/or module 826 in memory locations within RAM 808, computer-readable storage media within data storage unit 812, peripheral computer-readable storage media 802, and/or other tangible computer-readable storage media.

What we claim is:

1. A computer-implemented method for releasing account information to a network device, said method comprising:
receiving, over a communication network, from a first network device that has installed thereon an application, a first input, wherein said first input comprises a request for access to profile specific information associated with a second network device having installed thereon said application, wherein said profile specific information is stored at a cloud computing environment;
determining an identification of said first network device to achieve a determined identification;
comparing said determined identification to a set of user identities stored at said cloud computing environment; and
based on said comparing, if said determined identification matches at least a portion of said set of user identities, then allowing access to said profile specific information.

2. The computer-implemented method of claim 1, further comprising:
transmitting said profile specific information to said first network device.

3. The computer-implemented method of claim 1, further comprising:
receiving, from said application service provider computing environment, a copy of said profile specific information.

4. The computing-implemented method of claim 3, wherein said receiving, from an application service provider computing environment, a copy of said profile specific information comprises:
receiving a user identity of said second network device.

5. The computer-implemented method of claim 3, further comprising:
storing, at said cloud computing environment, said copy of said profile specific information at said cloud computing environment.

6. The computer-implemented method of claim 1, wherein said determining an identification of said first network device comprises:
capturing information associated with said first network device.

7. An article of manufacture, which comprises a computer readable medium having stored therein a computer program for releasing account information to a network device, the computer program comprising:
a first code segment which, when executed on a computer, receives, over a communication network, from a first network device that has installed thereon an application, a first input, wherein said first input comprises a request for access to profile specific information associated with a second network device having installed thereon said application, wherein said profile specific information is stored at a cloud computing environment;
a second code segment which, when executed on said computer, determines determining an identification of said first network device to achieve a determined identification;
a third code segment which, when executed on said computer, compares said determined identification to a set of user identities stored at said cloud computing environment; and
a fourth code segment which, when executed on said computer, based on said comparing, if said determined identification matches at least a portion of said set of user identities, then allows access to said profile specific information;

8. The article of manufacture of claim 7, wherein said computer program further comprises:
a fifth code segment which, when executed on said computer, and if said determined identification matches at least a portion of said set of user identities, then allows access to said profile specific information.

9. The article of manufacture of claim 7, further comprising:
a sixth code segment which, when executed on said computer, receives a user identity of said network device user profile information.

10. The article of manufacture of claim 7, further comprises:
a seventh code segment which, when executed on said computer, stores, at said cloud computing environment, said copy of said profile specific information.

11. An account information releaser comprising:
a receiver configured for:
receiving, over a communication network, from a first network device that has installed thereon an application, a first input, wherein said first input comprises a request for access to profile specific information associated with a second network device having installed thereon said application, wherein said profile specific information is stored at a cloud computing environment; and
a processor configured for:
determining an identification of said first network device to achieve a determined identification;
comparing said determined identification to a set of user identities stored at said cloud computing environment; and
based on said comparing, if said determined identification matches at least a portion of said set of user identities, then allowing access to said profile specific information;
a transmitter configured for:
transmitting said profile specific information to said first network device; and
a memory device configured for storing said profile specific information.

12. The account information releaser of claim 11, wherein said receiver is further configured for:
receiving, from said application service provider computing environment, a copy of said profile specific information.

13. The account information releaser of claim 11, wherein said receiving further comprises:
receiving an identity of said second network device.

14. The account information releaser of claim 11, wherein said receiving, from said second network device, a copy of said profile specific information comprises:
storing, at said cloud computing environment, said copy of said profile specific information.

15. The account information releaser of claim 11, wherein said determining an identification of said first network device to achieve a determined identification comprises:
capturing information associated with said first network device.
